(19) United States
(12) Patent Application Publication
(10) Pub. No.: US 2011/0042311 A1
(43) Pub. Date: Feb. 24, 2011

(54) MEMBRANE SYSTEM

(75) Inventor: Roy Victor Ames, Hawthorne (AU)

Correspondence Address: BELL & ASSOCIATES, 58 West Portal Avenue No. 121, SAN FRANCISCO, CA, 94127, US

(73) Assignee: Aquan Clarus Holdings Pty Ltd., New South Wales (AU)

(21) Appl. No.: 12/859,136

(22) Filed: Aug. 18, 2010

(30) Foreign Application Priority Data
Aug. 18, 2009 (AU) 2009903891

(51) Int. Cl. B01D 61/22; C02F 1/44; B01D 65/02

(52) U.S. Cl. 210/636; 210/637; 210/137; 210/108

(57) ABSTRACT

According to the present invention there is provided a method and apparatus for treating a contaminated liquid, the method comprising feeding said liquid to a treatment tank containing a treatment medium in the form of a filtration membrane or a reactive surface, applying a siphon to said treatment tank to draw said liquid through said treatment medium, and discharging the resultant treated liquid from the treatment tank, wherein said siphon is actuated upon said treatment tank reaching a predetermined head pressure or level. The invention also provides a treated liquid when so treated by the inventive method or apparatus.

### RELATION TO OTHER APPLICATIONS

This application claims priority to and the benefit of Australian provisional patent application No. 2009903891, filed 18 Aug. 2009, entitled “Membrane System”.

### FIELD OF THE INVENTION

The present invention relates to filtration systems and in particular to filtration systems for liquid streams containing a solid particulate load.

The invention has been developed primarily for use as a relatively low energy means of separating matter from a solids-containing liquids-rich fluid stream whilst circumventing the requirement for actuated valves. The invention will be described hereinafter with reference to this application. However it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Known membrane systems used to filter liquids-rich fluid streams generally include a series of pumps to backwash the membrane. Each pump adds to the complexity, labour intensity and costs associated with the system.

International patent publication number WO 2005/070523 relates to a membrane filter unit for liquid or gaseous media. The filter unit comprises a bundle of capillary membranes which are open on at least one front surface side and which are cast in an area which is close to the end of the open membrane ends, in a sealing layer forming a hardened head part. The open membrane ends protrude on the outer side of the sealing layer. The sealing layer is arranged on a spacer element that has a layer which is penetrated by the capillary membranes and which is non-permeable in relation to the casting material which hardens in order to form the sealing layer. Cleansing of the membrane filter unit is necessarily a manual operation, which increases unit down-time. This, accordingly, reduces efficiency and increases labour-intensity.

German patent number DE 10 302 014 relates to an arrangement for rinsing filter membranes consists of a pump and a pressure vessel for storing the rinsing water. The rinsing process does not require an electrical, pneumatic or hydraulic supply. The rinsing volume flow is independent from the pump volume flow. This arrangement appears a relatively complex system characterised by numerous manual valves and other labour-intensive features.

French patent number FR 2,825,934 discloses a pump within the tank, which draws in a suspension and passes it through a tangential filter, which includes porous ceramic membranes. A filtrate is extracted, whilst the concentrate is rejected back into the tank. Preferred features include an air injection system, which oxygenates rejected concentrate. The module enclosure has an opening for entry of the suspension. The pump drawing in the suspension and the filter are located to the interior. The opening has an inlet filter, preferably with a clearing system. A solenoid valve rejects concentrate, either to the tank or to the inlet filter, where it sets up internal back-pressure. The clearing system associated with this system is again characterised by a manual clean-out, which increases unit down-time. This, accordingly, reduces efficiency and increases labour-intensity.

Dutch patent number NL 1 017 165C discloses a system wherein a valve automatically opens when the liquid pressure inside a vessel is removed, e.g. due to a pump failure. A valve for a vessel filled with liquid is opened by applying an external pressure to the valve or by the removal of the pressure inside the vessel. The pressure applied to the valve in order to keep it closed is proportional to the pressure acting upon the valve inlet. The valve system, operated as it is, by external pressure is energy intensive and relatively inefficient.

German patent number DE 10 120 410 discloses an assembly to collect rain water, the assembly having a cistern to hold the rain water carried in through an inflow pipe, and a filter. The cistern has a unit to take off the stored water. The filter is cleaned from time to time by a pump, which takes water from the cistern to generate a flushing flow, to carry removed dirt into a soiled water outflow. The filter cleaning action is triggered by a sensor in the flow pipe to the filter, to register a water level backed up through a clogged filter. The use of at least one pump in the flushing operation is energy inefficient.

United States patent number U.S. Pat. No. 6,290,844 discloses a filter system for a pond system. The pond system comprises a pump vault arranged such that unfiltered water in a pond flows into the pump vault. The filter system comprises filter material adapted to remove impurities from unfiltered water to obtain filtered water and a frame structure connected to the pump vault cover for suspending the filter material within the pump vault. With this arrangement, unfiltered water first passes through the filter material before entering the pump. The filter material is removed from the pump vault for replacement and/or cleaning by removing the pump vault cover from the pump vault. Again, there are significant energy-inefficiencies associated with the use of the pump vault in both filtration and cleansing operations.

International patent publication number WO 99/40781 discloses a filter comprising an inlet, an outlet, a hollow member defining at least one passageway along which water to be filtered passes as it flows from the inlet to the outlet, water flow control means adjacent the inlet. The filter is such that, in use, water enters the filter at a relatively reduced flowrate which does not attract already separated solids, which instead, settle in a housing. Accordingly, the passive separation of solids from the liquid stream is relatively slow, thereby giving rise to further process inefficiencies.

It is an object of the present invention to overcome or ameliorate at least one of the disadvantages of the prior art, or to provide a useful alternative.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

According to a first aspect of the present invention there is provided a method of treating a contaminated liquid, said method comprising the steps of:
feeding said contaminated liquid to a treatment tank containing a treatment medium;
applying a siphon to said treatment tank to draw said contaminated liquid through said treatment medium; and
discharging the resultant treated liquid from said treatment tank,
wherein said siphon is actuated upon said treatment tank reaching a predetermined head pressure or level.

In an embodiment, said treatment medium is a filtration medium comprising one or more filtration membranes, said method thereby operative to treat a liquid contaminated with a solids load.

In an embodiment, said one or more filtration membranes are hollow fibre filtration membranes, said liquid being provided to the exterior of said hollow fibre membranes and drawn inwardly therethrough.

In another embodiment, said one or more filtration membranes are hollow fibre filtration membranes, said liquid being provided to the interior of said hollow fibre membranes and drawn outwardly therethrough.

In another embodiment, said treatment medium is a reactive substrate comprising one or more reactive surfaces, said method thereby operative to treat a liquid contaminated with a chemical load.

In an embodiment, said treated liquid is discharged to a discharge tank. Preferably, said discharge tank includes a pump, said pump adaptable to provide a backwash to said treatment medium, thereby to actively pump said treated liquid to said discharge tank. More preferably, said pump is associable with a valve, thereby to regulate backwash pressure.

In an embodiment, said backwash pump is actuated when said treatment tank reaches a predetermined level thus removing liquid from said discharge tank and creating a differential pressure therebetween. Preferably, said differential pressure and the corresponding flowrate of the resultant siphon is adjustable by varying the level in the discharge tank at which pump out is initiated, thereby to give a substantially constant flowrate.

In an embodiment, if said differential pressure cannot be physically achieved a centrifugal booster pump intermediate said membranes and said discharge tank may be applied. Preferably, said centrifugal booster pump is associable with a valve, thereby to regulate backwash pressure. More preferably, said valve is manually operable.

In an embodiment, said backwash is conducted on-volume. In another embodiment, the inventive method preferably comprises a cleansing step to cleanse said treatment medium. Preferably, said cleansing step is performed at regular intervals.

In an embodiment, said cleansing step is performed when a predetermined quantity of residue remains on said treatment medium. Preferably, said cleansing step is performed in association with an air inlet to facilitate clean-out of said treatment medium.

In an embodiment, said cleansing step removes residue from said treatment medium by passing air bubbles from the upstream end of said treatment medium, through said medium, thereby to scour and lift said residue from said treatment medium.

In an embodiment, said cleansing step is characterised by a predetermined sequence of air pulses. Preferably, said predetermined sequence of air pulses comprise sequential ten second on/off periods.

In an embodiment, said cleansing step further removes said residue from said treatment tank.

In an embodiment, the backwash pressure to said treatment medium is adjustable. In an embodiment, said treatment tank is further associable with a clarifier to receive residue from said treatment tank following cleansing of said treatment medium.

In an embodiment, said liquid feed is selected from, but not limited to: domestic wastewater, a river, a canal, polluted steams, groundwater, stormwater.

In an embodiment, said predetermined head pressure is a function of the vertical displacement of said treatment tank with respect to said discharge tank. Preferably, said vertical displacement is of the order of 2 m.

In an embodiment, said treatment medium is adapted to treat approximately 720 L/day of said contaminated liquid. In an embodiment, said treatment medium is adapted to treat a maximum flowrate of approximately 50 L/h of said contaminated liquid. In an embodiment, the pressure of said backwash is sufficient to provide for adequate cleansing of a fouled treatment medium.

According to a second aspect of the present invention there is provided an apparatus for treating a contaminated liquid, said apparatus comprising:
means for feeding said contaminated liquid to a treatment tank containing a treatment medium;
means for applying a siphon to said treatment tank to draw said contaminated liquid through said treatment medium; and
means for discharging the resultant treated liquid from said treatment tank,
wherein said siphon is actuated upon said treatment tank reaching a predetermined head pressure or level.

In an embodiment, said treatment medium is a filtration medium comprising one or more filtration membranes, said method thereby operative to treat a liquid contaminated with a solids load.

In an embodiment, said one or more filtration membranes are hollow fibre filtration membranes, said liquid being provided to the exterior of said hollow fibre membranes and drawn inwardly therethrough.

In another embodiment, said one or more filtration membranes are hollow fibre filtration membranes, said liquid being provided to the interior of said hollow fibre membranes and drawn outwardly therethrough.

In another embodiment, said treatment medium is a reactive substrate comprising one or more reactive surfaces, said method thereby operative to treat a liquid contaminated with a chemical load.

In an embodiment, said treated liquid is discharged to a discharge tank. Preferably, said discharge tank includes a pump, said pump adaptable to provide a backwash to said treatment medium, thereby to actively pump said treated liquid to said discharge tank. More preferably, said pump is associable with a valve, thereby to regulate backwash pressure.

In an embodiment, said backwash pump is actuated when said treatment tank reaches a predetermined level thus removing liquid from said discharge tank and creating a differential pressure therebetween. Preferably, said differential pressure and the corresponding flowrate of the resultant siphon is adjustable by varying the level in the discharge tank at which pump out is initiated, thereby to give a substantially constant flowrate.

In an embodiment, if said differential pressure cannot be physically achieved a centrifugal booster pump intermediate said membranes and said discharge tank may be applied. Preferably, said centrifugal booster pump is associable with a valve, thereby to regulate backwash pressure. More preferably, said valve is manually operable.

In an embodiment, the apparatus further comprises a cleansing means adapted to cleanse said treatment medium. In an embodiment, said cleansing means is operable at regular intervals.

In an embodiment, said cleansing means is operable when a predetermined quantity of residue remains on said treatment medium. In an embodiment, said cleansing means is associable with an air inlet to facilitate clean-out of said treatment medium.

In an embodiment, said cleansing means is adapted to remove residue from said treatment medium by passing air bubbles from the upstream end of said treatment medium, through said medium, thereby to scour and lift said residue from said treatment medium.

In an embodiment, said cleansing means is characterised by a predetermined sequence of air pulses. Preferably, said predetermined sequence of air pulses comprise sequential ten second on/off periods.

In an embodiment, said cleansing means is further adapted to remove said residue from said treatment tank.

In an embodiment, the backwash pressure to said treatment medium is adjustable. In an embodiment, said treatment tank is further associable with a clarifier to receive residue from said treatment tank following cleansing of said treatment medium.

In an embodiment, said liquid feed is selected from, but not limited to: domestic wastewater, a river, a canal, polluted steams, groundwater, stormwater.

In an embodiment, said predetermined head pressure is a function of the vertical displacement of said treatment tank with respect to said discharge tank. Preferably, said vertical displacement is of the order of 2 m.

In an embodiment, said treatment medium is adapted to treat approximately 720 L/day of said contaminated liquid. In an embodiment, said treatment medium is adapted to treat a maximum flowrate of approximately 50 L/h of said contaminated liquid. In an embodiment, the pressure of said backwash is sufficient to provide for adequate cleansing of a fouled treatment medium.

In an embodiment, the backwash pump is arranged in a non-traditional configuration, such that the majority of the liquid flows in the normal “outlet” and out the “inlet”. The liquid is backwashed through a valve such that the amount entering the vessel is the same as the amount exiting the vessel. “Normal” flow only occurs during backwash. This means that the pump internals must be able to take reverse flow and this flow should not be significantly restricted when the pump is not running to allow the flow to proceed from the filtration tank to the discharge tank. A submersible pump or conventional centrifugal pump would be suitable. A diaphragm, metering or centrifugal pump with very small clearances would not be suitable.

In an alternative embodiment, the discharge tank is effectively replaced by an air bladder, incorporated within and operably associated with a bladder chamber. The air bladder contains a volume of air at a predetermined pressure. As the treated liquid flows into the bladder chamber, this serves to force some of the air out of the air bladder and into associated piping. The rate of discharge of air is restricted so as to provide relatively constant flowrate through the membranes.

This air can, preferably, be diverted through a non-return valve, to the air inlet to scour the filtration medium, as disclosed above.

An air compressor is then actuated, such that air is forced back into the air bladder, at increased pressure, thereby optimising the bladder volume. Accordingly, the treated liquid is forced back up the siphon pipe, thereby to create a backwash and re-initiate the above cycle. In such a circumstance, the valve can be manipulated to control the backwash pressure.

Alternatively, the air bladder may initially be empty such that the air compressor is activated when the bladder chamber becomes full of liquid (and turned off when the bladder chamber is empty). When turned off, the compressor allows air to flow from ‘in’ to ‘out’, thereby allowing bleeding out through the compressor.

According to a third aspect of the present invention there is provided a liquid, when treated by a method according to the first aspect of the present invention.

Those skilled in the art will appreciate that the defining term “treated” is used to refer to a liquid that is discharged from the inventive apparatus or resultant of the inventive method that has had its contaminant concentration decreased as a result. For example, in the embodiments where the treatment medium is one or more filtration membranes and the contaminated liquid bears a solids load, the “treated” liquid will bear a lesser solids load; and in the embodiments where the treatment medium is one or more reactive surfaces (e.g. activated carbon, etc.), the “treated” liquid will bear a lesser chemical load than the contaminated liquid.

Those skilled in the art will appreciate that the terms “siphon” and “pressure head” may be interchangeable, depending upon the precise system configuration adopted in practice.

### BRIEF DESCRIPTION OF THE DRAWINGS

A preferred embodiment of the invention will now be described, by way of example only, with reference to the accompanying drawings in which:

FIG. 1 is a schematic diagram of an apparatus to treat a contaminated liquid according to a preferred embodiment of the present invention;

FIG. 2 is a schematic diagram of a particularly preferred embodiment of the present invention, incorporating an air bladder backwash system; and

FIG. 3 is a schematic diagram of a “household modular” embodiment of the present invention, employing an “out-to-in” membrane system.

### PREFERRED EMBODIMENT OF THE INVENTION

A preferred embodiment of the present invention is exemplified with reference to FIG. 1 of the accompanying drawings. The apparatus 1 acts to filter an incoming liquid stream 3 of various materials such as solid particulate matter 2, sludges, organisms and microorganisms. The inlet stream 3 can be any liquids-rich stream including, but not limited to, domestic wastewater, a river, a canal, polluted steams, groundwater, stormwater, drinking water, etc.

The apparatus comprises a filtration tank 4 having an inlet 5 through which the stream 3 enters. The filtration tank 4 comprises a filtration medium 6. In a particularly preferred embodiment, the filtration medium 6 comprises a number of cartridges or bundles of filtration membranes 7, such as hollow fibre membranes, which are connected at either end by suitable manifolds for ingress and egress of fluids. The filtration tank 4 also includes an outlet port 8 for exit of the treated filtrate 12.

The apparatus preferably further includes a discharge tank 11 adapted to receive a flow of the filtrate 12, via a pipeline 9 from the filtration tank 4. The level in the discharge tank 11 is positioned below the level in the filtration tank 4 such that gravity can feed fluid from the filtration tank 4 through the membrane 7 to the discharge tank 11. A backwash pump 13 is positioned within the discharge tank 11 and is selectively operable in response to fluid levels in the filtration tank 4 and discharge tank 11, as will be discussed below.

The apparatus optionally includes a solids clarifier 18 to receive the solids residue 2 from the filtration step, i.e. solids 2, or other material removed from the inlet stream 4, as will be discussed below.

In use, the apparatus operates as follows: The liquid inlet stream 3 enters the filtration tank 4 via the inlet 5. As a progressively greater volume of the inlet stream 3 enters the tank 4, the liquid level in the tank continues to rise until it reaches a predetermined level 19. The backwash pump 13 is preferably initiated to flush the pipeline 9 and pump any liquid in the discharge tank out of the system down to a second predetermined level and remove any air in the line.

The differential head created by a rising level in the filtration tank and a falling level in the discharge tank creates a head pressure 10 in the filtration tank 4 which is sufficient to initiate siphoning of the liquid from the outlet port 8 into the discharge tank 11. This siphoning via pipeline 9 effectively draws the liquid 3 through the filtration medium 6, thereby filtering the solid or other matter 2 from the inlet stream 3. The resultant liquid filtrate 12 is thereupon siphoned into the discharge tank 11.

The rate of liquid passing through the membranes is dependent upon the available head. Also, the maximum operating head will depend on the physical characteristics of the membrane used, the amount of fouling present upon the membrane and the composition of the fluid-bearing filters. To conserve energy, it would be preferable to rely on gravity only, however, physical and cost constraints will prevent the siphon head being more than about two metres. In this case, a centrifugal booster pump 25 may be inserted in the pipe 9 between the membranes and the “T-section” in the pipe 9 leading to non-return valve 15 and backwash pump 13.

As discussed above, the discharge tank 11 includes a backwash pump 13. The backwash pump may be initiated when the fluid level in the discharge tank 11 reaches a certain level. The backwash pump 13 has two functions. Firstly, the backwash pump 13 forces the liquid filtrate 12 back through pipe 9 into the filtration medium 6 to help agitate and clean the filtration membrane 7. The backwash pump 13 also simultaneously acts to pump out filtered liquid via a valve 15. Indeed, the non-return valve 15 may be adjusted to balance the amount of filtrate 12 pumped out of the system and the pressure of the backwash. The backwash pump turns off when the level falls to a predetermined lower level. The distance between the “pump on” and “pump off” is set to provide backwash at set time intervals for a given flowrate, as discussed below.

The flowrate through the membranes should be kept below a specified level from “start up” until when the membrane is cleaned. High flowrates can cause early fouling of the membranes, a significant reduction between the cleaning periods and a decrease in the lifespan of the membrane. To achieve this, the levels between that at which the backwash pump is initiated and that at which it is turned off are lowered due to the pressure required to keep constant flow being increased due to fouling. The membrane pump will not operate until the maximum gravity siphon is used.

When the level in the filtration tank falls below a predetermined level, the backwash pump will not operate. In such circumstances, the liquid then continues to siphon through the membranes with a gradual reduction in the differential levels until the flow stops. The relative diameters of the discharge tank and filtration tank are such that the level in the filtration tank is above the top of the membrane bundle when the flow stops.

As will be clear to persons skilled in the art, appropriate sizing of the backwash pump 13 will be required in order to provide sufficient pressure to effect backwash and pump out as required.

In regards to the size of the filtration tank 4, the principal factors are the volume above the membranes, the periods between flowrate into the tank and the flowrate through the membranes. The broad aim is to keep the time when the membranes are not operational to a minimum.

It will also be clear to those skilled in the art that appropriate sizing of the tank is required for different applications. In the treatment of wastewater, the tank can be fed from a recirculating trickle filter with overflows being recycled back to the recirculation. In this case, the size of filtration tank 4 is relatively minimised provided there is sufficient volume above the membranes to enable the tank to be filled during the recirculation “pump on” cycle.

Alternatively, the filtration tank 4 can be of a particular size that incorporates continuous treatment of the liquid in the filtration tank, such as the aerobic treatment of wastewater. For instance, if the device is being used in a domestic installation to treat so-called “grey water” from washing machines, baths, dishwashers, etc., flowrates may fluctuate significantly. Accordingly, the volume above the top of the membranes in the filtration tank 4 should be sufficiently large to handle such differences in flowrate.

The apparatus also preferably includes a cleaning mechanism to maintain efficiency. As the filtered residue 2 builds up on the filtration membranes 7, in the form of solid or other matter, it is preferable that this material is removed periodically to maintain efficacy of the apparatus. Persons skilled in the art will be aware of various options for removing such fouling material. However, one particularly preferred mechanism will be discussed.

As mentioned earlier, it is preferred that the filtration medium 6 comprises a plurality of hollow fibre membranes 7, stacked or bundled together. Such cartridges of hollow fibre membranes are well known in the art. However, there are significant difficulties with cleansing such filters. In one embodiment, the present invention provides an air cleansing/scouring system, which not only scours the residue on the membranes 7, but also removes the material from the filtration tank 4 to the solids clarifier 18.

To explain, the filtration tank 4 can include an air inlet 16. Thus, air is provided to the upstream side of the filtration membranes 7, as air bubbles 17. As the air bubbles 17 flow along the upstream surface of the membrane 7, they scour and lift the solid particulate matter 2 or other material, to the clarifier 18, whereupon the filtered solids, etc. settle out into a sediment bed for subsequent removal. For increased efficacy, this process can be carried out in conjunction with the aforementioned backwashing with the pump 13.

In a preferred embodiment of the present invention as discussed above, the preferred filtration medium 6 is a bundle or cartridge of large hollow fibre membranes 7. Preferably, the liquid 3 to be filtered is provided to the interior of the hollow fibres such that the siphoning draws the liquid outward. As a result, the air bubbles 17 should be provided similarly to the interior side of the hollow fibre membranes 7. Preferably, the hollow fibre membranes 7 are sized such that the air bubbles 17 effectively scour the interior of the fibre and lift the residue material out of the fibre for transfer to the clarifier 18.

In a further preferred embodiment, the backwash pump 13 is arranged in a non-traditional configuration, such that the majority of the liquid flows in the normal ‘outlet’ and out the ‘inlet’. “Normal” flow only occurs during backwash. This means that the pump internals must be able to take reverse flow and this flow should not be significantly restricted when the pump is not running to allow the flow to proceed from the filtration tank to the discharge tank. A submersible pump or conventional centrifugal pump would be suitable. A diaphragm, metering or centrifugal pump with very small clearances would not be suitable.

The treated water 12 may be removed from the system either directly from the storage tank 11, or via the valve 15. It will be appreciated that removal through the valve 15 does not necessarily require the backwash pump to be initiated. To this end, the storage tank may be by-passed altogether such that the treated stream 12 is siphoned through the valve 15 upon treatment.

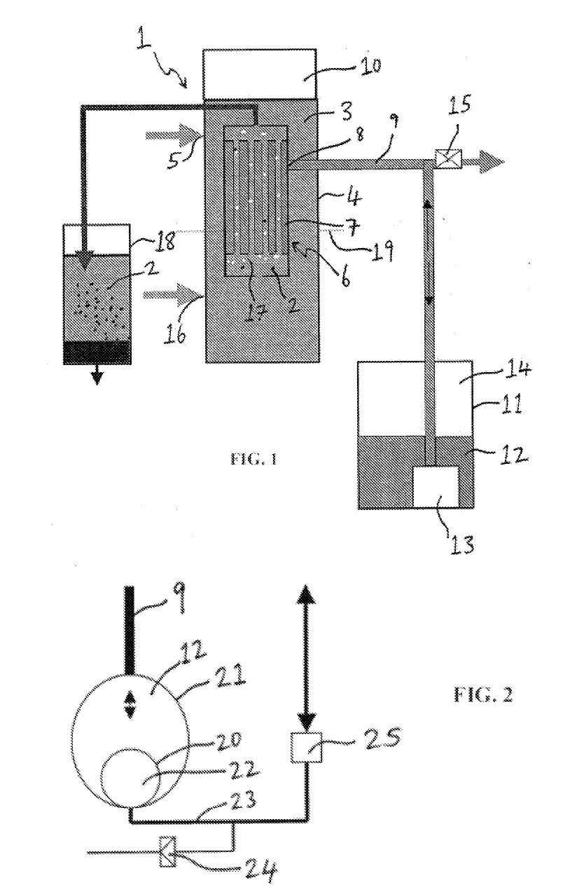

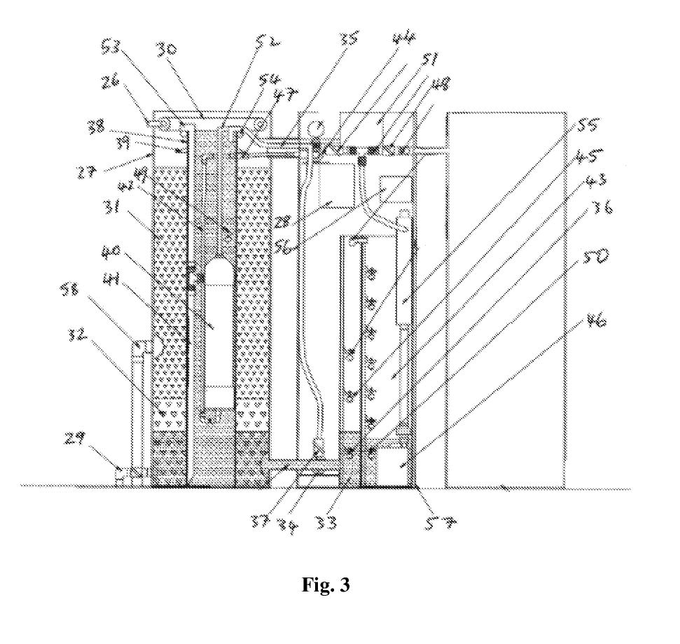

Referring now to FIG. 2 of the accompanying drawings, in a particularly preferred embodiment, the discharge tank 11 is effectively replaced by an air bladder 20, incorporated within and operably associated with a bladder chamber 21. The air bladder 20 contains a volume of air 22 at a predetermined pressure. As the treated liquid 12 flows into the bladder chamber 21, this serves to force some of the air 22 out of the air bladder 20 and into associated piping 23. This air can, preferably, be diverted through a non-return valve 24, to the air inlet 16 to scour the filtration medium 6, as disclosed above.

An air compressor 25 is then actuated, such that air 22 is forced back into the air bladder 20, at increased pressure, thereby optimising the bladder volume. Accordingly, the treated liquid 12 is forced back up the siphon pipe 9, thereby to create a backwash and re-initiate the above cycle. In such a circumstance, the valve 15 can be manipulated to control the backwash pressure.

Alternatively, the air bladder 20 may initially be empty such that the air compressor 25 is activated when the bladder chamber 21 becomes full of liquid 12 (and turned off when the bladder chamber 21 is empty). When turned off, the compressor 25 allows air 22 to flow from ‘in’ to ‘out’, thereby allowing bleeding out through the compressor 25.

Air release from the bladder is preferably adapted to be constricted to ensure it fills at a predetermined rate required to minimise fouling of the membranes.

It will be appreciated that this preferred embodiment enables the system to operate only one electrical device provided the head available between the filtration tank and the bladder is sufficient to eliminate the need for a booster pump in pipe 9.

Referring now to FIG. 3 of the accompanying drawings, one preferred embodiment of the inventive method comprises a greywater feed 26 being pumped from a collection sump (not shown) to the system treatment tank 27. The power to the external feed pump is connected to the system controller 28 so that the feed pump is turned off when the high water level switch 29 is activated. In various embodiments, the collection sump and/or the treatment tank may be placed above or below the ground level; they may be integral within a single module, or spaced apart from each other depending upon the physical constraints of the property in which the system is installed.

The greywater then flows through a removable filter 30 and then downward from around the circumference of the filter into the top of a trickle bed bioreactor 31 made of plastic pieces having a mean diameter of about 20 mm The liquid flows downward through the trickle bed 31 into a collection chamber 32 consisting of larger plastic pieces having a mean diameter of about of about 50 mm.

The liquid then equalises with a stand pipe 33 and is recirculated back to the trickle bed by recirculation pump 34 via pipe 35. A level switch 36 is positioned above the pump to prevent it running dry should the level drop below that of the switch. A manual valve 37 controls the rate of recirculation.

The recirculation “on times” are determined by a controller 28 and are set to ensure the conditions in the bioreactor 31 fluctuate between anoxic and aerobic, thereby to optimise treatment of the wastewater. The recirculation stream fills the filtration tank 38 before overflowing from the tank and being distributed over the trickle bed bioreactor 31 by the distribution cone 39.

A membrane cartridge 40 is positioned in the filtration tank 38. Liquid enters the cartridge 40 through a pipe 41 and flows through a series of hollow fibres from outside to inside. This “out-to-in” membrane feature is but one characterising feature of the present invention. The filtered liquid is withdrawn from the bottom of the cartridge 40 and siphoned through a pipe 42 into a discharge tank 43. From this discharge tank, the filtered liquid is then siphoned through a centrifugal pump 44, a UV cartridge 45 and a backwash pump 46. Notably, the siphon though the backwash pump is in the reverse direction to the normal flow when the pump is operating. When the backwash pump operates, the liquid flows back through the pipe 47 to backwash the membranes and then out of the system though a pipe 48. A non-return valve is positioned within the pipe 48 to prevent backflow and/or loss of siphon.

The backwash pump 46 does not operate when the liquid level is below a level switch 49. Prior to feed entering the system, the above-mentioned siphon will have resulted in levels equalising below the level switch 49.

When the liquid level in the filtration tank 38 reaches the level switch 49, the backwash pump starts and continues to operate until level in the discharge tank falls to a specific level switch, as discussed below. This in turn drives any air to accumulated in the system and creates a differential head upon which siphoning commences.

The flow though the membranes 40 is set as low as possible within the constraints of the required daily flow. This maximises the lifespan of the membranes. This minimal flowrate may be achieved as follows:

A series of probes in the form of level switches are positioned in the discharge tank 50. Initially, the backwash pump will be stopped by the controller when the second probe from the top is reached. Liquid will siphon due to the differential head until the top probe is reached. The controller will record the time at which this is to occur. With new membranes, the uppermost two probes are those used for “pump on” and “pump off”, respectively. As the membranes become fouled through use, the flowrate will slow and the time between probes will be extended. In such circumstances, the controller will then select the third probe down for “pump off” and second probe down for “pump on”, and so on until the bottom two probes are controlling the backwash pump.

If the flow slows further, the controller is then activated and starts the centrifugal pump 44. This will be “variable speed”-controlled, so that the required flowrate is maintained; the pump will have a maximum flow setting. The membrane pump will not operate if the level falls below the level switch 49. If there is a sudden surge of liquid into the system (e.g. a domestic bath being discharged), then the level switch 49 operates via centrifugal pump 44, and the “maximum” flowrate is operative.

In a relatively simplified embodiment, the number of level switches in the discharge tank may be reduced to two—and the centrifugal pump eliminated so that the system acts only on siphon.

During the backwash cycle, the aerator 51 will be turned on for an approximate period of 20 seconds prior to the backwash pump being turned on; it will be turned off when the backwash pump is turned off. The air enters the membrane through the pipe 52 and scours the outside of the membrane. The air lifts the dirty water up the pipe 53, out of the distribution pipe 54, and over the distribution cone 39 to the top of the trickle bed bioreactor.

The flowrate will typically be set at 50 L/h for a 720 L/day system. The distance between level probes 49 in the discharge tank will be approximately 200 mm, which will result in a backwash every 10 mm Allowance is made for 10% of the liquid pumped out passing back through the membranes on pump out.

The pressure of the backwash is set by valve 48 and this is sufficient to provide for adequate cleansing of a fouled treatment medium, as may be indicated on the pressure gauge 44. The backwash time should be a minimum of around 7 seconds.

The discharge tank, recirculation pump 34, stand pipe 33, controller 28, aerator 51, centrifugal membrane pump 44, UV 55, UV controller 56 and associated pipework are all positioned in a module that has a removable front and preferably visibly matches the treatment tank. An additional matching water tank can be positioned beside the cabinet 57.

The inventive system is equipped with an audio alarm and a red alarm light. These are activated if the UV lamp fails or the high level switch 29 is activated. In the latter case, some or all of the liquid being treated will flow to an associated sewer until the fault is rectified. The audio alarm can be muted by pushing a button. In the case of a malfunction in the UV, the backwash pump is disabled and the system overflows to the sewer through an overflow pipe 58 until the fault can be rectified. These indicators and switches are preferably positioned on the front of the cabinet 57. An optional extra is a telephone dialout to indicate that the system is alarming.

Solids that build up in the bottom of the treatment tank are drained to the sewer during service. The membranes are cleaned at around six-monthly intervals and the UV globe replaced annually.

It will be appreciated that the exemplified membrane filtration systems provide for the effective separation of solid particulate or other matter from an otherwise liquids-rich fluid stream. It will be further appreciated that the illustrated membrane filtration systems are relatively simple, place relatively little stress on the membrane due to low pressures, are effectively self-controlled and incorporate an effective and efficient cleaning and solids removal system.

Although the invention has been described with reference to specific examples, it will be appreciated by those skilled in the art that the invention may be embodied in many other forms.

1. A method of treating a contaminated liquid, said method comprising the steps of:
feeding said contaminated liquid to a treatment tank containing a treatment medium;
applying a siphon to said treatment tank to draw said contaminated liquid through said treatment medium; and
discharging the resultant treated liquid from said treatment tank,
wherein said siphon is actuated upon said treatment tank reaching a predetermined head pressure or level.

2. A method according to claim 1, wherein said treatment medium is a filtration medium comprising one or more filtration membranes, said method thereby operative to treat a liquid contaminated with a solids load.

3. A method according to claim 1, wherein said treatment medium is a reactive substrate comprising one or more reactive surfaces, said method thereby operative to treat a liquid contaminated with a chemical load.

4. A method according to claim 2, wherein said one or more filtration membranes are hollow fibre filtration membranes, said liquid being provided to the exterior of said hollow fibre membranes and drawn inwardly therethrough; or said liquid being provided to the interior of said hollow fibre membranes and drawn outwardly therethrough.

5. A method according to claim 1, wherein said treated liquid is discharged to a discharge tank including a pump, said pump adaptable to provide a backwash to said treatment medium, thereby to actively pump said treated liquid to said discharge tank.

6. A method according to claim 5, wherein said backwash pump is actuated when said treatment tank reaches a predetermined level thus removing liquid from said discharge tank and creating a differential pressure therebetween.

7. A method according to claim 6, wherein if said differential pressure cannot be physically achieved a centrifugal booster pump intermediate said membranes and said discharge tank may be applied.

8. A method according to claim 1, further comprising a cleansing step to cleanse said treatment medium, said cleansing step characterised by a predetermined sequence of air pulses.

9. A method according to claim 1, wherein the backwash pressure to said treatment medium is adjustable.

10. A method according to claim 1, wherein said treatment tank is further associable with a clarifier to receive residue from said treatment tank following cleansing of said treatment medium.

11. A method according to claim 5, wherein the pressure of said backwash is sufficient to provide for adequate cleansing of a fouled treatment medium.

12. An apparatus for treating a contaminated liquid, said apparatus comprising:
means for feeding said contaminated liquid to a treatment tank containing a treatment medium;
means for applying a siphon to said treatment tank to draw said contaminated liquid through said treatment medium; and
means for discharging the resultant treated liquid from said treatment tank,
wherein said siphon is actuated upon said treatment tank reaching a predetermined head pressure or level.

13. An apparatus according to claim 12, wherein said treatment medium is a filtration medium comprising one or more filtration membranes, said method thereby operative to treat a liquid contaminated with a solids load.

14. An apparatus according to claim 12, wherein said treatment medium is a reactive substrate comprising one or more reactive surfaces, said method thereby operative to treat a liquid contaminated with a chemical load.

15. An apparatus according to claim 13, wherein said one or more filtration membranes are hollow fibre filtration membranes, said liquid being provided to the exterior of said hollow fibre membranes and drawn inwardly therethrough; or said liquid being provided to the interior of said hollow fibre membranes and drawn outwardly therethrough.

16. An apparatus according to claim 12, wherein said treated liquid is discharged to a discharge tank including a pump, said pump adaptable to provide a backwash to said treatment medium, thereby to actively pump said treated liquid to said discharge tank.

17. An apparatus according to claim 16, wherein said backwash pump is actuated when said treatment tank reaches a predetermined level thus removing liquid from said discharge tank and creating a differential pressure therebetween.

18. An apparatus according to claim 17, wherein if said differential pressure cannot be physically achieved a centrifugal booster pump intermediate said membranes and said discharge tank may be applied.

19. An apparatus according to claim 12, further comprising a cleansing means adapted to cleanse said treatment medium, said cleansing means characterised by a predetermined sequence of air pulses.

20. An apparatus according to claim 12, wherein the backwash pressure to said treatment medium is adjustable.

21. An apparatus according to claim 12, wherein said treatment tank is further associable with a clarifier to receive residue from said treatment tank following cleansing of said treatment medium.

22. An apparatus according to claim 16, wherein the pressure of said backwash is sufficient to provide for adequate cleansing of a fouled treatment medium.

23. A liquid, when treated by a method according to claim 1.
